(19) United States
(12) Patent Application Publication
(10) Pub. No.: US 2024/0107429 A1
(43) Pub. Date: Mar. 28, 2024

(54) Machine Learning Non-Standalone Air-Interface

(71) Applicant: Telefonaktiebolaget LM Ericsson (publ), Stockholm (SE)

(72) Inventors: Ursula Challita, Solna (SE); Henrik Rydén, Stockholm (SE)

(21) Appl. No.: 17/768,919

(22) PCT Filed: Nov. 3, 2020
(86) PCT No.: PCT/EP2020/080846

§ 371 Date: Apr. 14, 2022

Related U.S. Application Data
(60) Provisional application No. 62/930,027, filed on Nov. 4, 2019.

(51) Int. Cl. H04W 48/16; H04W 28/08

(52) U.S. Cl. CPC H04W 48/16; H04W 28/08

(57) ABSTRACT

The present disclosure generally relates to wireless communication methods and wireless communication networks, more particularly to for example wireless communication networks comprising fully end-to-end Machine Learning based air-interfaces.

### TECHNICAL FIELD

The present disclosure generally relates to wireless communication methods and wireless communication networks, more particularly to for example wireless communication networks comprising fully end-to-end Machine Learning based air-interfaces.

### BACKGROUND

Future wireless networks might comprise a fully end-to-end machine learned air-interface. The challenges are training a machine learned air-interface that does not only supports efficient data transmissions, but also mimicking an efficient control channel, that handles typical control channel problems such as for example being energy efficient in situations where no data is transmitted nor received (for example scheduling, paging and random access).

In New Radio (NR), also referred to as the 5^{th} generation of cellular technology (5G) non-standalone network, the network uses an NR-carrier mainly for data-rate improvements, while the carrier used in LTE is used for non-data tasks such as mobility and initial cell search.

### SUMMARY

Next-generation network analytics driven by artificial intelligence (AI) and machine learning (ML), and AI powered wireless communication networks, promise to revolutionize the conventional operation and structure of current networks from network design to radio resource management, infrastructure management, cost reduction, and user performance improvement. Future wireless communication networks, also simply referred to as wireless networks, might comprise a fully end-to-end machine learned air-interface. Empowering future networks with AI functionalities will enable a shift from reactive/incident driven operations to proactive/data driven operations.

Evolution to the 5^{th} generation cellular technology (5G), also referred to as New Radio (NR), and beyond networks will see an increase in network complexity—from new use cases to network function virtualization, large volumes of data, and different service classes such as ultra-reliable low latency communications (URLLC), massive machine type communications (mMTC), and enhanced mobile broadband (eMBB). The increased complexity is forcing a fundamental change in network operations. Meanwhile, the recent advances in AI promises to address many complex problems in wireless networks.

Intelligent network applications and features can aid in augmenting the human capabilities to improve the network efficiency and assist operators in managing the operational expenditure. As such, integrating AI functions efficiently in future networks is a key component for increasing the value of 5G and beyond networks. AI will inevitably have a significant role in shaping next generation wireless cellular networks—from AI-based service deployment to policy control, resource management, monitoring, and prediction. Evolution to AI-powered wireless networks is triggered by the improved processing and computational power, access to massive amount of data, and enhanced software techniques thus enabling an intelligent radio access network and the spread of massive AI devices. Integrating AI functionalities in future networks will allow such networks to dynamically adapt to the changing network context in real-time enabling autonomous and self-adaptive operations. Network devices can implement both reactive and proactive approaches for the different types of applications.

However, there currently exist certain challenges. These challenges lie for example in training the interface between wireless devices, wherein such wireless device may be for example a user equipment (UE) and an AI-reinforced network node, or ML-reinforced node. The interface should not only support efficient data transmissions, but also for example mimicking an efficient control channel, that handles complex tasks such as paging and random access. In NR non-standalone, the network uses an NR-carrier mainly for data-rate improvements, while the carrier of an LTE based system is used for non-data tasks such as mobility and initial cell search.

Proposed ML based communication networks comprise an air-interface with always on data-transmissions. The list of further challenges for potential ML based air-interfaces is extensive, and comprises for example:
how to train the ML air-interface,
how to monitor paging messages,
how to schedule UEs with ML,
how to configure UEs going into power saving mode,
how to handle mobility?

Certain aspects of the present disclosure and embodiments thereof may provide solutions to some or all of these, or other, challenges.

One aspect of the disclosure provides a method of using a control layer (for example LTE or NR control layer) to provide information of how to communicate on an ML based air-interface.

According to another aspect the disclosure provides a framework that utilizes an ML air-interface targeting improving the data transmissions, while being served by a control layer on another frequency and RAT, similar to the first NR non-standalone deployments.

The primary RAT could both be used to train the ML air-interface, or during training of the ML based air-interface, and for controlling signalling details regarding how the UEs should communicate on the ML-air-interface. Thus, the primary RAT could for example be used for sending the weights of a neural network (NN), i.e. relevant at training, or provide information regarding when/where the UE should receive data, i.e. relevant at control signalling.

In general terms, training of a NN network is performed by applying a training data set, for which the correct outcome is known, and iterate that data through the NN. During training of the NN the weights associated with respective node, or connection from respective node, increase or decrease in strength, meaning that how probable it is that a specific connection, out of the many possible, from a node, that is selected when a node is reached is adjusted. Generally, for each training iteration of the NN, the chance that the outcome when applying the NN is correct increases.

According to embodiments, training the neural network could for example comprise of what bits the receiver should expect from the transmitter, and the receiver could feedback for example the loss. The network could for example update/train a potential autoencoder based on the loss and feedback the updated weights to the transmitter/receiver.

As is apparent for a person skilled in the art, training of a neural network and/or an autoencoder can be done according to various, commonly known methods of which a few will be discussed more in detail below. Both neural networks and autoencoders are further discussed below.

In New Radio (NR), also referred to as the 5^{th} generation of cellular technology (5G) non-standalone network, the network uses an NR-carrier mainly for data-rate improvements, while the carrier used in LTE is used for non-data tasks such as mobility and initial cell search.

In the context of communication networks, implementing a telecommunication standard such as for example LTE, NR or any other wireless communication standard, the information flows over the different protocol layers are known as channels. The channels are distinguished by the kind of information or data that is carried by the channel and by the way the information or data is processed. Channels are generally divided into three categories; logical channels (what type of Information), transport channels (how the information is transported) and physical channels (where to send the information). Information or data can be transmitted over a channel either downlink, meaning from for example a Radio Access Network (RAN) node, such as for example a gNB, to a wireless device, such as for example a UE, or uplink, meaning the opposite direction.

Logical channels can further be divided into two categories, as control channels and traffic channels. Traffic channels carry data in the user plane. Control channels carry signalling messages in the control plane, and they can be either common channels or dedicated channels. A common channel means common to all users in a cell (Point to multipoint) whereas Dedicated channels means channels can be used only by one user (Point to Point).

Thus, communication or signalling over the control channel may also be referred to as communication or signalling of the control plane or control layer. Examples of network operations or procedures which are controlled by signalling over the control channel is for example paging and random access. Signals transmitted over the control channel may be referred to as control signals.

One simplified aspect of the disclosure can be summarized by the method steps disclosed below. According to some embodiments, as disclosed below, a second network entity, also denoted ML-node or second node, comprises a Machine Learning (ML) based Air-interface, while the first network entity, also denoted first node, supports any other RAT such as for example WCDMA, LTE or NR.
1) A UE, i.e. wireless device, signals its capabilities in supporting an ML based air-interface to first node, over suitable RAT, for example NR,
2) Based on step 1, the first node signals control information to the UE and the ML-node, for example by using the same RAT,
3) The UE receives/transmits wireless signals intended for the ML-node, over the same RAT, by using the control plane of the first node,
4) The ML-node provides information to the first node regarding the communication between the UE and the ML-node, and
5) The first node updates control information based on step 4.
   Note that the first node and the ML-node may be located in the same base station (i.e. in the same radio access entity).

There are, proposed herein, various embodiments which address one or more of the issues disclosed herein.

A first embodiment of the present disclosure relates to a computer implemented method for managing a network interface of a communication network, the communication network comprising a Radio Access Network (RAN), the method being performed by a wireless device in the communication network, the method comprising:
transmitting capabilities in supporting communication, by means of a first wireless communication system, towards a first network entity, the capabilities in supporting communication comprising capabilities of the wireless device in supporting communication to a second network entity,
receiving control information, by means of the first wireless communication system, transmitted by the first network entity in response to the wireless device transmitting the capabilities in supporting communication towards the first network entity,
wherein the control information comprises information defining how to receive and/or transmit wireless signals transmitted by/towards the second network entity by using the control information of the first network entity, and
transmitting wireless signals towards and/or receiving wireless signals transmitted by, a second network entity.

A second embodiment of the present disclosure relates to a wireless device in a communication network, the communication network comprising a Radio Access Network, the wireless device being configured to:
transmit capabilities in supporting communication, by means of a first wireless communication system, towards a first network entity, the capabilities in supporting communication comprising capabilities of the wireless device in supporting communication to a second network entity,
receive control information, by means of the first wireless communication system, transmitted by the first network entity in response to the wireless device having transmitted the capabilities in supporting communication towards the first network entity,
wherein the control information comprises information defining how to receive and/or transmit wireless signals transmitted by/towards the second network entity by using the control information of the first network entity, and
transmitting wireless signals towards and/or receiving wireless signals transmitted by, a second network entity.

A third embodiment of the present disclosure relates to a computer implemented method for managing a network interface of a communication network, the communication network comprising a Radio Access Network, the method being performed by a first network entity in the communication network, the method comprising:
receiving capabilities in supporting communication, by means of a first wireless communication system, transmitted by a wireless device, the capabilities in supporting communication comprising capabilities of the wireless device in supporting communication to a second network entity, and
in response to receiving capabilities in supporting communication transmitted by the wireless device:
transmitting control information, by means of the first wireless communication system, towards the wireless device and by means of a second communication system towards the second network entity,
wherein the control information comprises information defining how to transmit wireless signals between the wireless device and the second network entity by using the control information of the first network entity.

A fourth embodiment of the present disclosure relates to a first network entity in a communication network, the communication network comprising a Radio Access Network (RAN), the first network entity being configured to:
receive capabilities in supporting communication, by means of a first wireless communication system, transmitted by a wireless device, the capabilities in supporting communication comprising capabilities of the wireless device in supporting communication to a second network entity, and
in response to receiving capabilities in supporting communication transmitted by the wireless device:
transmit control information, by means of the first wireless communication system, towards the wireless device and by means of a second communication system towards the second network entity,
wherein the control information comprises information defining how to transmit wireless signals between the wireless device and the second network entity by using the control information of the first network entity.

A fifth embodiment of the present disclosure relates to a computer implemented method for managing a network interface of a communication network, the communication network comprising a Radio Access Network, the method being performed by a second network entity in the communication network, the method comprising:
receiving control information, by means of a second communication system, transmitted by a first network entity,
wherein the control information comprises information defining how to receive and/or transmit wireless signals transmitted by/towards a wireless device by using the control information of the first network entity, and
transmitting wireless signals towards and/or receiving wireless signals transmitted by, the wireless device.

A sixth embodiment of the present disclosure relates to a second network entity in a communication network, the communication network comprising a Radio Access Network (RAN), the second network entity being configured to:
receive control information, by means of a second communication system, transmitted by a first network entity,
wherein the control information comprises information defining how to receive and/or transmit wireless signals transmitted by/towards a wireless device by using the control information of the first network entity, and
transmit wireless signals towards and/or receive wireless signals transmitted by, the wireless device.

A list of further exemplary, numbered, embodiments of the present disclosure is provided below:

Embodiment 1 refers to a method performed by a wireless device in a communication network for managing network interfaces, the method comprising:
transmitting capabilities in supporting communication, by means of a first wireless communication system, towards a first network entity, the capabilities in supporting communication comprising capabilities of the wireless device in supporting communication to a second network entity
receiving control information, by means of the first wireless communication system, transmitted by the first network entity in response to transmitting the capabilities in supporting communication towards the first network entity,
wherein the control information comprises information defining how to receive and/or transmit wireless signals transmitted by/towards the second network entity by using the control information of the first network entity, and
transmitting wireless signals towards and/or receiving wireless signals transmitted by, a second network entity.

Embodiment 2 refers to the method performed by the wireless device according to embodiment 1, wherein the second network entity is an Artificial Intelligence, AI, reinforced network entity, and
wherein the capabilities in supporting communication, transmitted by the first network entity, comprises information supporting providing a Machine Learning, ML, based air-interface between the wireless device and the second network entity.

Embodiment 3 refers to the method performed by the wireless device according to embodiment 2, wherein the Machine Learning, ML, based air-interface is configured for handling and/or improving data transmission between the wireless device and the second network entity.

Embodiment 4 refers to the method performed by the wireless device according to embodiment 2 or 3, wherein the control information enables:
training of the Machine Learning, ML, based air-interface, and/or
controlling wireless signalling between the wireless device and the second network entity.

Embodiment 5 refers to the method performed by the wireless device according to any one of embodiments 1 to 4, wherein the first wireless communication system is any one of a number of available Radio Access Technologies, RATs.

Embodiment 6 refers to the method performed by the wireless device according to embodiment 5, wherein the wireless communication system may be any one of: a WCDMA based communication system, an LTE based communication system or a New Radio, NR, based communication system.

Embodiment 7 refers to the method performed by the wireless device according to any one of embodiments 1 to 6, wherein the capabilities in supporting communication may comprise information regarding at least one of, or any combination of:
frequencies and bandwidths supported by the wireless device,
processing capabilities of the wireless device,
one or more supported neural network, NN, configurations that can be processed by the wireless device,
energy requirements of the wireless device,
throughput requirements of the wireless device,
latency requirements of the wireless device,
reliability requirements of the wireless device,
information regarding if the wireless device is capable of assisting in training a Machine Learning, ML, based air-interface,
information regarding capabilities of storing data and/or storing Machine Learning, ML, models of the wireless device, and/or
a unique identifier or identity of the wireless device.

Embodiment 8 refers to the method performed by the wireless device according to any one of embodiments 1 to 7, wherein the control information may comprise information regarding one, or a combination of:
package size of packages being transmitted between the wireless device and the second network entity,
the time-frequency resources and packet where the wireless device should transmit its uplink transmission, and/or
the time-frequency resources and packet where the wireless device can expect to receive a downlink transmission from the second network entity,
machine learning, ML, model describing how to decode a wireless signal transmitted from the second network entity, comprising data intended for the wireless device, wherein the model describing how to decode the signal may comprise information regarding:
   Neural Network, NN, structure, and/or
   Neural Network, NN, weights for decoding the signal.

Embodiment 9 refers to the method performed by the wireless device according to embodiment 8, when being dependent on embodiment 2,
and in case the control information is used for training the Machine Learning, ML, based air-interface, the control information may comprise information regarding at least one of, or a combination of:
   the packet transmitted from the second network entity, or from the wireless device,
   a pseudo-random function that can be used to efficiently generate the transmitted packet from the second network entity, or from the wireless device,
   the time-frequency resources and packet where the wireless device should transmit its uplink transmission, and/or
   the time-frequency resources and packet where the wireless device can expect to receive a downlink transmission from the second network entity.

Embodiment 10 refers to a wireless device in a communication network, the wireless device being configured to:
transmit capabilities in supporting communication, by means of a first wireless communication system, towards a first network entity, the capabilities in supporting communication comprising capabilities of the wireless device in supporting communication to a second network entity,
receive control information, by means of the first wireless communication system, transmitted by the first network entity in response to having transmitted the capabilities in supporting communication towards the first network entity,
wherein the control information comprises information defining how to receive and/or transmit wireless signals transmitted by/towards the second network entity by using the control information of the first network entity, and
transmitting wireless signals towards and/or receiving wireless signals transmitted by, a second network entity.

Embodiment 11 refers to the wireless device according to embodiment 10, and further being configured to perform any of the methods of embodiment 2 to 9.

Embodiment 12 refers to a method performed by a first network entity in a communication network for managing network interfaces, the method comprising:
receiving capabilities in supporting communication, by means of a first wireless communication system, transmitted by a wireless device, the capabilities in supporting communication comprising capabilities of the wireless device in supporting communication to a second network entity, and
in response to receiving capabilities in supporting communication transmitted by the wireless device:
transmitting control information, by means of the first wireless communication system, towards the wireless device and by means of a second communication system towards the second network entity,
wherein the control information comprises information defining how to transmit wireless signals between the wireless device and the second network entity by using the control information of the first network entity.

Embodiment 13 refers to the method performed by the first network entity according to embodiment 12, the method further comprising the method step of:
receiving feedback information, by means of the second communication system, transmitted by the second network entity,
wherein the feedback information comprises an acknowledgement message acknowledging that the control information is received and/or information about the communication between the wireless device and the second network entity.

Embodiment 14 refers to the method performed by the first network entity according to embodiment 13, the method further comprising the method step of:
updating the control information based on the received feedback information.

Embodiment 15 refers to the method performed by the first network entity according to any one of embodiments 12 to 14, wherein the second network entity is an Artificial Intelligence, AI, reinforced network entity, and
wherein the capabilities in supporting communication, transmitted by the first network entity, comprises information supporting providing a Machine Learning, ML, based air-interface between the wireless device and the second network entity.

Embodiment 16 refers to the method performed by the first network entity according to embodiment 15, wherein the Machine Learning, ML, based air-interface is configured for handling and/or improving data transmission between the wireless device and the second network entity.

Embodiment 17 refers to the method performed by the first network entity according to embodiment 15 or 16, wherein the control information enables:
training the Machine Learning, ML, based air-interface, and/or
controlling wireless signalling between the wireless device and the second network entity.

Embodiment 18 refers to the method performed by the first network entity according to any one of embodiments 15 to 17, wherein the feedback information may comprise at least on of:
and acknowledgement message acknowledging that the control information is received, and
in case of receiving data packets using the Machine Learning, ML, based air-interface:
packet error and/or need for re-transmission of a packet,
output from a neural network, NN, at the wireless device, and/or
application specific events needed for triggering model update, and
in case of training the Machine Learning, ML, based air-interface:
bit-error loss, and/or
gradients for backpropagation in a neural network, NN.

Embodiment 19 refers to a first network entity in a communication network, the first network entity being configured to:
receive capabilities in supporting communication, by means of a first wireless communication system, transmitted by a wireless device, the capabilities in supporting communication comprising capabilities of the wireless device in supporting communication to a second network entity, and
in response to receiving capabilities in supporting communication transmitted by the wireless device:
transmit control information, by means of the first wireless communication system, towards the wireless device and by means of a second communication system towards the second network entity,
wherein the control information comprises information defining how to transmit wireless signals between the wireless device and the second network entity by using the control information of the first network entity.

Embodiment 20 refers to the first network entity according to embodiment 19, and further being configured to perform any of the methods of embodiment 13 to 18.

Embodiment 21 refers to the first network entity according to embodiment 19 or 20, wherein the first network entity and the second network entity are located in one radio access entity.

Embodiment 22 refers to a method performed by a second network entity in a communication network for managing network interfaces, the method comprising:
receiving control information, by means of a second communication system, transmitted by a first network entity,
wherein the control information comprises information defining how to receive and/or transmit wireless signals transmitted by/towards a wireless device by using the control information of the first network entity, and
transmitting wireless signals towards and/or receiving wireless signals transmitted by, the wireless device.

Embodiment 23 refers to the method performed by the second network entity according to embodiment 22, the method further comprising the method step of:
transmitting feedback information, by means of the second wireless communication system,
wherein the feedback information comprises an acknowledgement message acknowledging that the control information is received and/or information about the communication between the wireless device and the second network entity.

Embodiment 24 refers to the method performed by the second network entity according to embodiment 19, wherein the second network entity is an Artificial Intelligence, AI, reinforced network entity, — and wherein the second network entity is configured to provide a Machine Learning, ML, based air-interface between the wireless device and the second network entity.

Embodiment 25 refers to the method performed by the second network entity according to embodiment 24, wherein the Machine Learning, ML, based air-interface is configured for handling and/or improving data transmission between the wireless device and the second network entity.

Embodiment 26 refers to the method performed by the second network entity according to embodiment 24 or 25, wherein the control information enables:
training the Machine Learning, ML, based air-interface, and/or
controlling wireless signalling between the wireless device and the second network entity.

Embodiment 27 refers to a second network entity in a communication network, the second network entity being configured to:
receive control information, by means of a second communication system, transmitted by a first network entity,
wherein the control information comprises information defining how to receive and/or transmit wireless signals transmitted by/towards a wireless device by using the control information of the first network entity, and
transmit wireless signals towards and/or receive wireless signals transmitted by, the wireless device.

Embodiment 28 refers to the second network entity according to embodiment 27, the second network entity being an Artificial Intelligence, AI, reinforced network entity, and wherein the second network entity is configured to provide a Machine Learning, ML, based air-interface between the wireless device and the second network entity.

Embodiment 29 refers to the second network entity according to embodiment 27 or 28, wherein a first network entity and the second network entity are located in one radio access entity.

Embodiment 30 refers to the second network entity according to any one of embodiments 27 to 29, and further being configured to perform any one of the methods of embodiment 23, 25 or 26.

Embodiment 31 refers to a computer program comprising computer-executable instructions, or a computer program product comprising a computer readable medium, the computer readable medium having the computer program stored thereon, wherein the computer-executable instructions enabling a wireless device to perform the method steps of any one of embodiments 1 to 9 when the computer-executable instructions are executed on a processing unit of a wireless device.

Embodiment 32 refers to a computer program comprising computer-executable instructions, or a computer program product comprising a computer readable medium, the computer readable medium having the computer program stored thereon, wherein the computer-executable instructions enabling a network entity to perform the method steps of any one of embodiments 12 to 18 or 22 to 26 when the computer-executable instructions are executed on a processing unit of a network entity.

When herein referring to: by means of, what is considered is by using. Thus, the terms: by means of and: by using can be used interchangeably. For example, what is intended with: (transmitting capabilities in supporting communication) by means of a first wireless communication system, is that information regarding capabilities in supporting communication is transmitted by using, which also may be referred to as: over, a first communication system.

Managing network interfaces is herein considered to comprise various aspects of network management, and may, but is not limited to include, setting-up/establishing and/or continuously maintaining, including for example updating parameters.

Certain aspects or embodiments of the disclosure may provide one or more of the following technical advantages, and may provide one or more of the following technical effects. The disclosure enables communication over an ML based air-interface using the control layer of a primary carrier, i.e. over what herein generally is referred to as first wireless communication system, using suitable RAT. Using the control layer of the primary carrier simplifies deployment and continuous operation of an ML based air-interface, i.e. AI interface. Having a control layer provided by another RAT enables signalling of ML-specific information while communicating on an ML based air-interface. This allows for more training feedback. If the ML based air-interface is configured to improve transmission, aspects of the embodiments provide improved data rates, by leveraging the scenario-specific adaptation powered by applying AI functionality. Having for example signalling and training provided by a first network entity for example facilitates deployment, increases flexibility and improves reliability, while providing for example improved data rate transmission, or improving other aspect of the network, by means of the ML based air-interface. The present disclosure enables such arrangement.

In addition to what previously has been stated as being enabled by next generation of wireless communication networks, next generation of wireless communication networks may also provide advantages in terms of for example significant savings, or improved usage, of resources like for example bandwidth, energy, data storage capacity, processing power and processing time, which will be crucial for realizing future communication networks.

### BRIEF DESCRIPTION OF THE DRAWINGS

FIG. 1 schematically discloses a potential future Machine Learning (ML) based air-interface solution with an AI-interface supported by a control plane on another Radio Access Technology (RAT), according to some embodiments of the disclosure

FIG. 2a schematically discloses a method involving a wireless device, a first network entity and a second network entity according to some embodiments of the disclosure,

FIG. 2b schematically discloses a method involving a wireless device according to some embodiments of the disclosure,

FIG. 2c schematically discloses a method involving a first network entity according to some embodiments of the disclosure,

FIG. 2d schematically discloses a method involving a second network entity according to some embodiments of the disclosure,

FIG. 3a and FIG. 3b schematically disclose a module-based Machine Learning (ML) based air-interface and a module structure according to some embodiments of the disclosure,

FIG. 4 discloses a table, Table 1, summarizing the benefits and challenges of autonomous node-level AI, localized AI, and global AI, according to some embodiments of the disclosure,

FIG. 5 discloses a potential communication chain according to some embodiments of the disclosure,

FIG. 6 discloses decision regions for UE non-equalized symbol, according to some embodiments of the disclosure,

FIGS. 7a and 7b disclose measured and predicted network coverage on 28 GHz and 3.5 GHz according to some embodiments of the disclosure,

FIG. 8 is a schematic block diagram of a network entity according to some embodiments of the disclosure,

FIG. 9 is a schematic block diagram of a network node (for example a core network entity) according to some embodiments of the present disclosure,

FIG. 10 is a schematic block diagram of a wireless device according to some embodiments of the present disclosure, and

FIG. 11 is a schematic block diagram of a wireless device according to some other embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein. Thus, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

According to a first embodiment of the disclosure communication over a Machine Learning (ML) based air-interface is enabled by using a control plane and control signals from a primary carrier using a first wireless communication system, i.e. a Radio Access Technology (RAT) such as for example an LTE based communication system or e New Radio (NR) based communication system. The ML based air-interface is in this context considered to be a third wireless communication system.

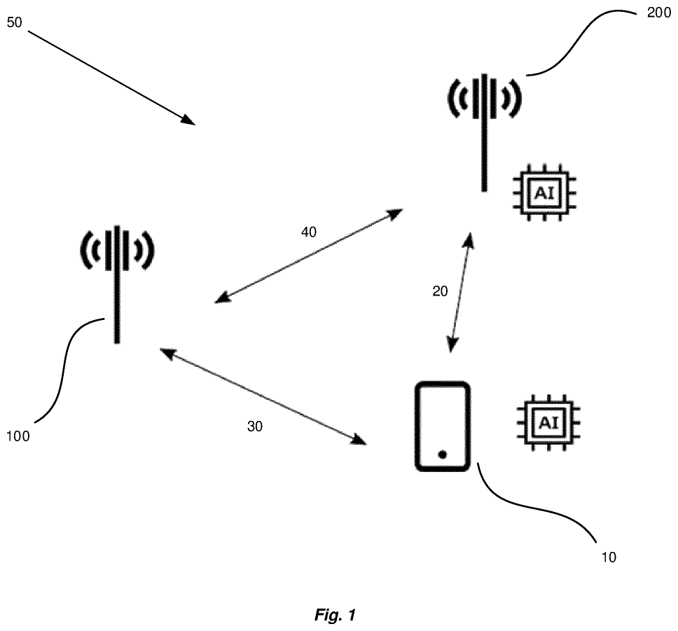

FIG. 1 schematically discloses one embodiment of a communication network 50 comprising a potential future ML based air-interface solution with an AI-interface supported by a control plane on another Radio Access Technology (RAT). FIG. 1 discloses a first network entity 100, also referred to as first node and a second network entity, also referred to as second node 200, interacting with a wireless device 10, also referred to as a UE. The second node 200, also denoted ML-node, supports a Machine Learning (ML) based air-interface 20 to the wireless device 10. The first node 100 supports any other RAT interface, herein referred to as first network interface 30, to the wireless device 10. The RAT applied for providing the first network interface 30, herein referred to as first communication system, may be based on for example WCDMA, LTE or NR technology

As will be further discussed below, the first wireless communication system may be, or may use, any one of a number of available Radio Access Technologies, RATs, such as anyone of for example: a WCDMA based communication system, an LTE based communication system or a New Radio, NR, based communication system.

According to embodiments of the disclosure, the ML based air-interface 20 may be considered to be a third communication system, i.e. a wireless communication system not applying any one of the commonly recognized RATs of the first wireless communication system or means of communicating of the second communication system. According to embodiments the ML based air-interface 20 may be an over-the-air-interface, i.e. air interface, comprising, or being controlled by, a plurality of trainable parameters. The trainable parameters may be trained using conventional methods, for example by applying neural network backpropagation. With other words, a network interface which functionality and capability is controlled by a number of parameters, and wherein a plurality of those parameters are trainable, i.e. are adjustable or configurable by being trained. Exemplary trainable parameters when using a neural network are its weights and/or biases. Neural network backpropagation is an algorithm widely used in the training of any type of neural network, such as feedforward neural networks for supervised learning, and is one example of potential training methods that can be used. The skilled person will recognize that also other training methods are applicable.

The first node 100 and the second node 200 are also connected by means of a second network interface 40, herein referred to as a second communication system. According to embodiments of the disclosure, the communication, or signalling, between the first network entity 100 and the second network entity 200, i.e. the ML-node, may not be over an air-interface, but may be for example over a wired interface, such as for example over a fiber based interface. According to aspects of the disclosure the XN and/or XG interface in NR, or x2 interface in LTE may be used. It is also possible to use the same RAT as used for the first network interface 30 between the wireless device 10 and the first network node 100.

According to other embodiments, the signalling between first network entity 100 and the second network entity 200 may be done using proprietary signalling.

According to embodiments of the disclosure, the ML based air-interface 20 may be deployed in the same frequency as for example an NR carrier, for example at 28 Ghz, using spectrum sharing.

Exemplary embodiments of the disclosure provide the exemplary advantages; that the first wireless communication system, such as a primary RAT, can be used to: 1) train the ML based air-interface 20, and for 2) controlling signalling details regarding how the wireless device 10 should communicate on the ML based air-interface 20, for example sending the weights of a neural-network (NN) with the ML-node, or when/where the wireless device 10 should receive data.

FIG. 1 will be further discussed below.

According to embodiments, the first wireless communication system, also referred to as for example telecommunications network, cellular network or communication network, may in some embodiments, be configured to operate according to specific standards, for example as defined by the 3^{rd} Generation Partnership Project (3GPP), or other types of predefined rules or procedures. Thus, particular embodiments of the communication system may implement communication standards, such as Global System for Mobile Communications (GSM), Universal Mobile Telecommunications System (UMTS), Long Term Evolution (LTE), New Radio (NR) and/or other suitable 2G, 3G, 4G, 5G or future generations of standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Examples of network entities 100, 200, or nodes, include, but are not limited to, access points (APs) (for example, radio access points), base stations (BSs) (for example, radio base stations, Node Bs, evolved Node Bs (eNBs) and NR NodeBs (gNBs)). Further examples of network entities include but are not limited to core network functions such as, for example, core network functions in a Fifth Generation (5G) Core network (5GC). Examples of 5GC network functions include, but are not limited to the Access and Mobility Management function (AMF), Session Management function (SMF) and Network Slice Selection Function (NSSF).

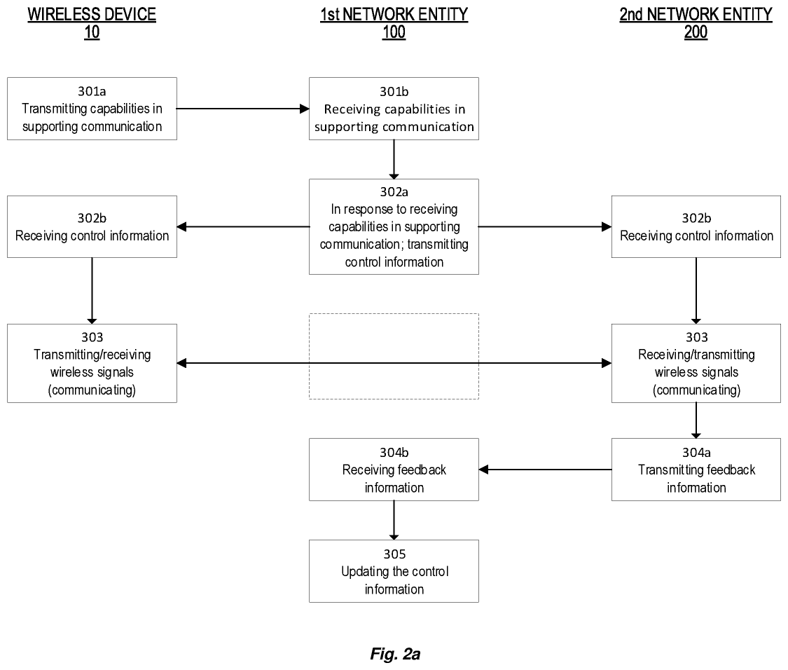

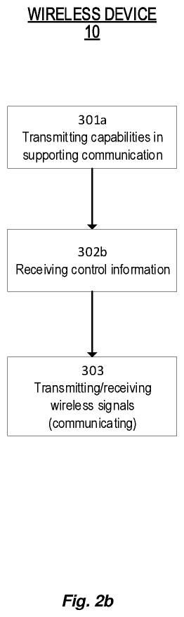

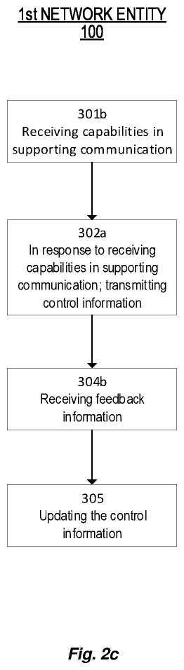

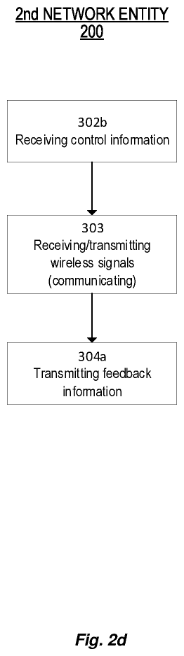

FIG. 2a schematically discloses a method involving a wireless device 10, a first network entity 100 and a second network entity 200 according to some embodiments of the disclosure, and will below be discussed starting from the perspective of; a) a wireless device 10 (some embodiment of method performed by wireless device 10 also disclosed in FIG. 2b), b) a first network entity 100 (some embodiment of method performed by first network entity 100 also disclosed in FIG. 2c), and c) a second network entity 200 (some embodiment of method performed by second network entity 200 also disclosed in FIG. 2d).
a) from the perspective of the wireless device 10, the method comprises the method steps of:
   301a transmitting capabilities in supporting communication, by means of a first wireless communication system, towards a first network entity 100, the capabilities in supporting communication comprising capabilities of the wireless device 10 in supporting communication to a second network entity 200,
   302b receiving control information, by means of the first wireless communication system, transmitted by the first network entity 100 in response to transmitting the capabilities in supporting communication towards the first network entity 100
   (i.e. receiving control information transmitted by the first network entity in response to that the first network entity having received the transmitted capabilities in supporting communication),
   wherein the control information comprises information defining how to receive and/or transmit wireless signals transmitted by/towards the second network entity 200 by using the control information of the first network entity 100, and
   303 transmitting wireless signals towards and/or receiving wireless signals transmitted by, a second network entity 200.
b) from the perspective of the first network entity 100, the method comprises the method steps of:
   301b receiving capabilities in supporting communication, by means of a first wireless communication system, transmitted by a wireless device 10, the capabilities in supporting communication comprising capabilities of the wireless device 10 in supporting communication to a second network entity 200, and in response to receiving capabilities in supporting communication transmitted by the wireless device 10:
   302a transmitting control information, by means of the first wireless communication system, towards the wireless device 10 and by means of a second communication system towards the second network entity 200,
   wherein the control information comprises information defining how to transmit wireless signals between the wireless device 10 and the second network entity 200 by using the control information of the first network entity 100.
c) from the perspective of the second network entity 200, the method comprises the method steps of:
   302b receiving control information, by means of a second communication system, transmitted by a first network entity 100,
   wherein the control information comprises information defining how to receive and/or transmit wireless signals transmitted by/towards a wireless device 10 by using the control information of the first network entity 100, and
   303; transmitting wireless signals towards and/or receiving wireless signals transmitted by, the wireless device 10.

Put another way, the control information address how to transmit/receive wireless signals intended for data transmission, and may comprise information regarding the capabilities of the wireless device 10 to receive and/or transmit data transmitted by/towards the second network entity 200, and/or, as will be discussed more in detail below, information regarding the capabilities of the wireless device 10 to learn and improve how to receive and/or transmit data transmitted by/towards the second network entity 200.

According to one embodiment, the wireless signal may for example be transmitted from an antenna device located in the second network entity 200. However, the second network entity 200 may also be a virtual machine, such as for example a cloud-server, that only generates the wireless signal, whereby the wireless signal is relayed via an antenna device located at the first network entity 100.

From the perspective of the second network entity 200, some embodiments may also comprise the method steps of:
304a transmitting feedback information, by means of the second wireless communication system,
wherein the feedback information comprises an acknowledgement message acknowledging that the control information is received and/or information about the communication between the wireless device 10 and the second network entity 200.

From the perspective of the first network entity 100, some embodiments may also comprise the method steps of:
304b receiving feedback information, by means of the second communication system, transmitted by the second network entity 200,
wherein the feedback information comprises an acknowledgement message acknowledging that the control information is received and/or information about the communication between the wireless device 10 and the second network entity 200, and potentially also:
305 updating the control information based on the received feedback information.

According to embodiments, the control information may for example be updated based on the feedback of data transmission, i.e. if the data transmission between the second network entity and the wireless device is successful the control information is adjusted to the describe next packet to be transmitted. If NACK (not acknowledged) is received, then the network might send control information relating to for example a new ML based decoder that the wireless device should use instead of what previously has been communicated.

According to embodiments of the present disclosure, the latter example may for example refer to an embodiment where an autoencoder is used to facilitate and/or improve efficiency of communication between the wireless device 10 and the second network entity 200. Generally, an autoencoder comprises fully connected, feed-forward neural networks with an encoder-decoder architecture, meaning that the autoencoder comprises an encoder neural network and a decoder neural network, wherein the respective neural networks have been trained together. Autoencoders are generally used to reduce dimensionality of data, without losing information comprised in the data, or to denoise data. The encoder part of the autoencoder is fed with input data and outputs a compressed representation of that data. The encoder takes the compressed representation of the data and outputs a reconstructed representation of the data fed to the encoder.

According to embodiments the encoder may be implemented at a transmitter side of a transmitter-receiver arrangement, and the decoder may be implemented at the receiver side. The encoder may be used to encode for example network parameters or measurement reports, whereas the decoder part, when applied to the encoded representation of for example network parameters or measurement reports, reconstruct the encoded data. Autoencoders are further discussed below.

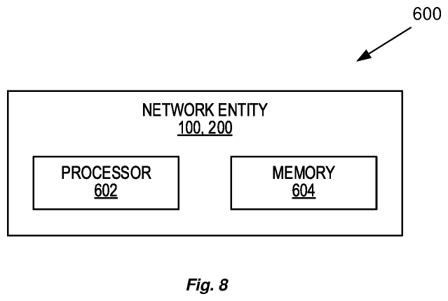

Generally, a network entity 100, 200 may comprise any component or network function (for example any hardware or software module) in the communications network suitable for performing the methods disclosed herein. In some embodiments the node may comprise the node 600 as described with respect to FIG. 8 below.

According to one embodiment the communication may comprise the following signalling;

Capabilities in supporting communication, i.e. capability signalling; A wireless device, such as a user equipment (UE), can report its capabilities to a primary node, i.e. first network entity, in supporting an ML based air-interface, wherein the report may comprise at least one of: frequencies and bandwidths supported by the wireless device 10, processing capabilities of the wireless device 10, one or more supported neural network, NN, configurations that can be processed by the wireless device 10, energy requirements of the wireless device 10, throughput requirements of the wireless device 10, latency requirements of the wireless device 10, reliability requirements of the wireless device 10, information regarding if the wireless device 10 is capable of assisting in training a Machine Learning, ML, based air-interface 20, information regarding capabilities of storing data and/or storing Machine Learning, ML, models of the wireless device 10, and/or a unique identifier or identity of the wireless device 10.

Control information, i.e. control information signalling; The control signal returned to the wireless device, for example UE, from the primary carrier, i.e. from the first network entity or first node, and/or transmitted to the second network entity, i.e. second node, may comprise at least one of: package size of packages being transmitted between the wireless device 10 and the second network entity 200, the time-frequency resources and packet where the wireless device 10 should transmit its uplink transmission, and/or the time-frequency resources and packet where the wireless device 10 can expect to receive a downlink transmission from the second network entity 200, machine learning, ML, model describing how to decode a wireless signal transmitted from the second network entity 200 comprising data intended for the wireless device 10, wherein the ML model describing how to decode the signal may comprise information regarding: Neural Network, NN, structure, and/or Neural Network, NN, weights for decoding the signal.

And in case the control information is used for training the Machine Learning, ML, based air-interface 20, the control information may comprise information regarding one, or a combination of: the packet transmitted from the second network entity 200, or from the wireless device 10, a pseudo-random function that can be used to efficiently generate the transmitted packet from the second network entity 200, or from the wireless device 10, the time-frequency resources and packet where the wireless device 10 should transmit its uplink transmission, and/or the time-frequency resources and packet where the wireless device 10 can expect to receive a downlink transmission from the second network entity 200.

Feedback information, i.e. feedback signalling; the feed-back signalling transmitted by the second network entity 200 towards the first network entity 100 may comprise: and acknowledgement message acknowledging that the control information is received, and
in case of receiving data packets using the Machine Learning, ML, based air-interface 20: packet error and/or need for re-transmission of a packet, output from the neural network, NN, at the wireless device 10, and/or application specific events needed for triggering an ML model update, and
in case of training the Machine Learning, ML, based air-interface 20: bit-error loss, and/or gradients for backpropagation in a neural network, NN.

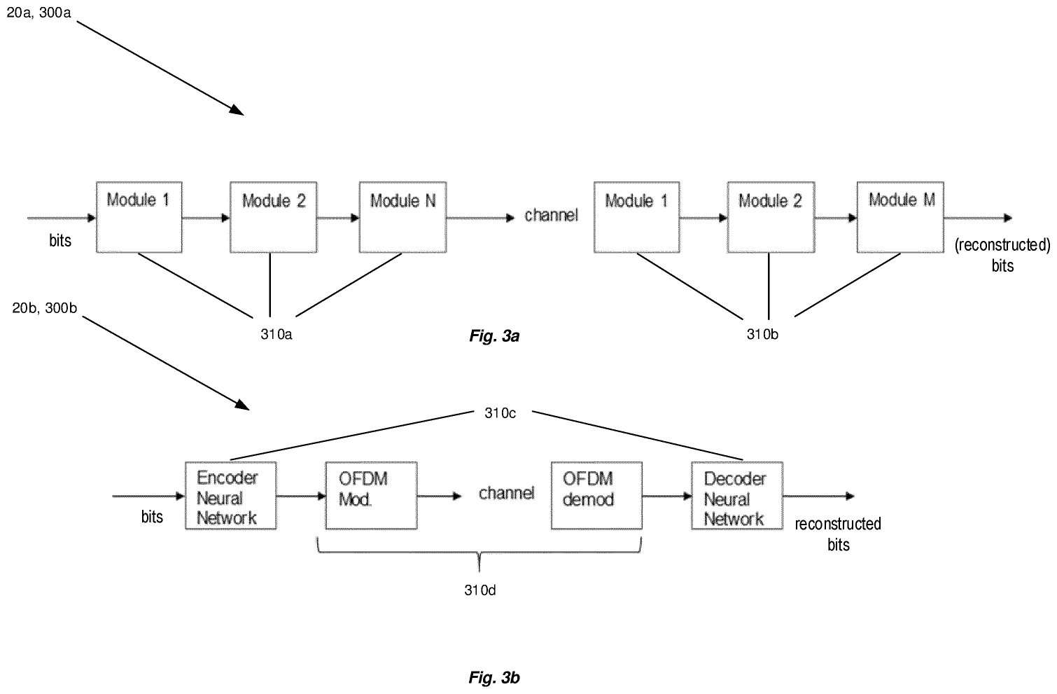

FIG. 3a schematically discloses an exemplary embodiment of a module-based, Machine Learning (ML) based air-interface 20a, comprising of an exemplary embodiment of a module structure 300a, also referred to as block structure. FIG. 3a schematically discloses a general exemplary embodiment with N modules 310a at a transmitter side, and M modules 310b at a receiver side of the ML based air-interface 20a.

One further exemplary embodiment of a module-based, Machine Learning (ML) based air-interface 20b, comprising of an exemplary embodiment of a module structure 300b is schematically shown in FIG. 3b.

According to embodiments the transmitter side may be in form of a wireless device, such as a UE, and the receiver side may be in form of a second network entity, also referred to as a second network node. In the exemplary embodiments shown in FIGS. 3a and 3b the data or information fed to the module structure 300 (i.e. 300a, 300b) is represented by, and hereafter referred to as, bits. The bits may for example represent measurement data resulting from signal quality measurements performed by the UE and/or by device specific information. The ML based air-interface 20 (i.e. 20a, 20b) further comprises a traffic channel, in FIGS. 3a and 3b simply indicated as channel.

The ML based air-interface 20 may comprise a set of modules 310 (i.e. 310a, 310b, 310c, 310d), wherein by combining a number of modules 310 an ML based air-interface 20 communication chain may be established. The control information, provided by the first network entity, or the first network node, may comprise a module description of each module 310, i.e. may comprises for example what input/output that can be expected to/from a module, or any other module specific information, of respective module 310.

According to embodiments, an ML based air-interface 20 may comprise a set of trainable modules 310 and a set of non-trainable modules 310. Herein, trainable module means a module that can be trained using any conventional machine learning techniques such as for example backpropagation. An example of a trainable module is a Neural Network (NN) module, or as schematically disclosed in FIG. 3b, a cooperative pair of NN modules 310c, forming an encoder-decoder architecture. As schematically indicated in FIGS. 3b (and 3a), according to embodiments the encoder NN module, of the transmitting side of the ML based air-interface 20b, may be used to encode the input bits, and after the encoded representation of the input bits have been transferred, or transmitted, to the receiving side of the ML based air-interface 20b, via the channel, the decoder NN can reconstruct the encoded representation of the input bits, in FIGS. 3b (and 3a) schematically indicated by reconstructed bits. Encoder-decoder structures are further discussed below.

The modules 310 are not restricted to for example Neural Networks (NN), but may also comprise for example fast Fourier Transform (FFT), Non-Orthogonal Multiple Access (NOMA) or Orthogonal Frequency Division Multiplexing (OFDM) blocks, or modules. The exemplary module structure 300b of FIG. 3b schematically discloses that the trainable modules 310c are used to train/learn the symbols that should be transmitted on each OFDM subcarrier by non-trainable modules 310d. According to embodiments, control signalling related to the OFDM block may comprise of the subcarrier spacing, cyclic prefix used and/or number of subcarriers. According to further embodiments, selecting the modules forming the ML based air-interface 20 may be based on the capabilities of the UE, signalled by the UE, and/or on energy and/or throughput requirements. For example, energy constrained devices may use a NN structure with fewer layers, reducing the energy spent in processing wireless signals from the second network entity, to the cost of reduced throughput. Similarly, using an OFDM module with low number of subcarriers are more energy efficient than using OFDM with more subcarriers.

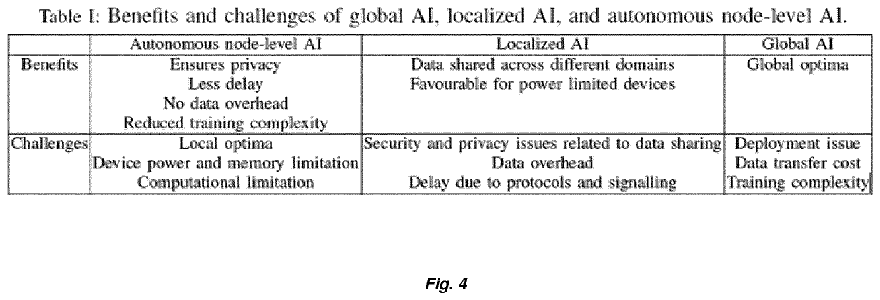

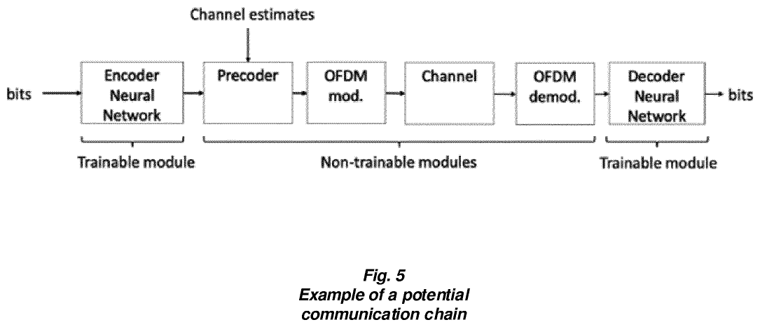

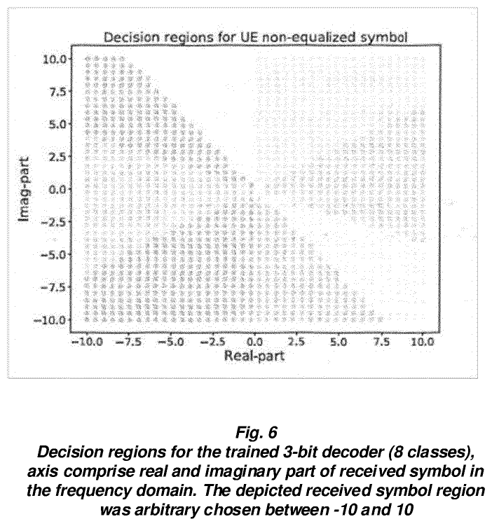

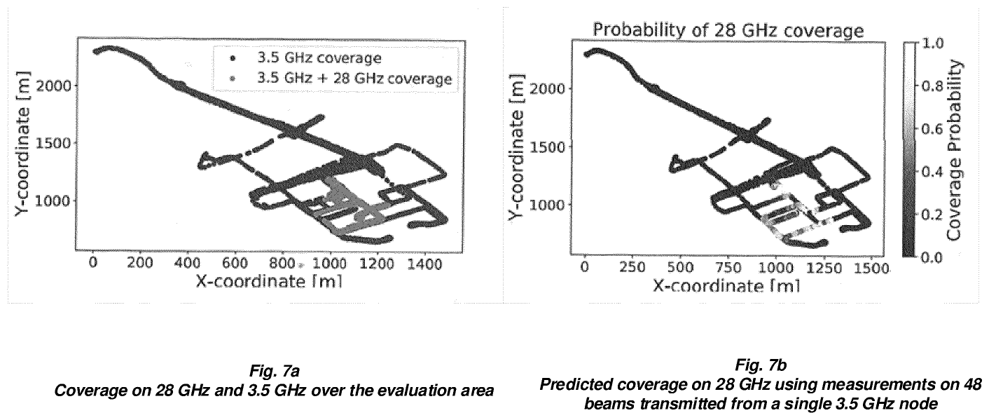

FIG. 4, FIG. 5, FIG. 6, FIG. 7a and FIG. 7b are discussed under Further exemplary embodiments.

Turning now to other embodiments; FIG. 8 disclosing an exemplary network entity 600, generally also referred to as node, network node, base station, radio access entity or radio base station, in a wireless communication network according to some embodiments herein.

The network entity 600 is configured (for example adapted or programmed) to perform any of the embodiments of methods performed by a network entity described herein. When referring to network entity below all, or certain aspects, may apply both to the first network entity and/or to the second network entity. Additionally, as will be discussed below, the first and/or second network entity may also comprise additional functionalities even though not explicitly mentioned herein.

Generally, the network entity, below generally referred to as node, 600 may comprise any component or network function (for example any hardware or software module) in the communications network suitable for performing the functions described herein. For example, a node may comprise equipment capable, configured, arranged and/or operable to communicate directly or indirectly with a wireless device, below generally referred to simply as UE, and/or with other network nodes or equipment in a wireless communication network to enable and/or provide wireless access to the UE and/or to perform other functions (for example, administration) in the communications network. Examples of nodes include, but are not limited to, access points (APs) (for example, radio access points), base stations (BSs) (for example, radio base stations, Node Bs, evolved Node Bs (eNBs) and NR NodeBs (gNBs)). Further examples of nodes include but are not limited to core network functions such as, for example, core network functions in a Fifth Generation Core network (5GC).

The node 600 may be configured or operative to perform the methods and functions described herein, such as embodiments of the methods disclosed in relation to FIG. 2. The node 600 may comprise processing circuitry, also referred to as processor or logic, 602. It will be appreciated that the node 600 may comprise one or more virtual machines running different software and/or processes. The node 600 may therefore comprise one or more servers, switches and/or storage devices and/or may comprise cloud computing infrastructure or infrastructure configured to perform in a distributed manner, that runs the software and/or processes.

The processor 602 may control the operation of the node 600 in the manner described herein. The processor 602 can comprise one or more processors, processing units, multi-core processors or modules that are configured or programmed to control the node 600 in the manner described herein. In particular implementations, the processor 602 may comprise a plurality of software and/or hardware modules that are each configured to perform, or are for performing, individual or multiple steps of the functionality of the node 600 as described herein.

The node 600 may comprise a memory 604. In some embodiments, the memory 604 of the node 600 can be configured to store program code or instructions that can be executed by the processor 602 of the node 600 to perform the functionality described herein. Alternatively, or in addition, the memory 604 of the node 600, can be configured to store any requests, resources, information, data, signals, or similar that are described herein. The processor 602 of the node 600 may be configured to control the memory 604 of the node 600 to store any requests, resources, information, data, signals, or similar that are described herein.

It will be appreciated that the node 600 may comprise other components in addition or alternatively to those indicated in FIG. 8. For example, in some embodiments, the node 600 may comprise a communications interface. The communications interface may be for use in communicating with other nodes in the wireless communication network, (for example such as other physical or virtual nodes). For example, the communications interface may be configured to transmit to and/or receive from other nodes or network functions requests, resources, information, data, signals, or similar. The processor 602 of node 600 may be configured to control such a communications interface to transmit to and/or receive from other nodes or network functions requests, resources, information, data, signals, or similar.

Once again referring to FIG. 1, according to embodiments of the disclosure the first network entity 100 may be configured to:
receive capabilities in supporting communication, by means of a first wireless communication system, transmitted by a wireless device 10, the capabilities in supporting communication comprising capabilities of the wireless device 10 in supporting communication to a second network entity 200, and
in response to receiving capabilities in supporting communication transmitted by the wireless device 10:
transmit control information, by means of the first wireless communication system, towards the wireless device 10 and by means of a second communication system towards the second network entity 200,
wherein the control information comprises information defining how to transmit wireless signals between the wireless device 10 and the second network entity 200 by using the control information of the first network entity 100.

According to other embodiments of the disclosure the second network entity 200 may be configured to:
receive control information, by means of a second communication system, transmitted by a first network entity 100,
wherein the control information comprises information defining how to receive and/or transmit wireless signals transmitted by/towards a wireless device 10 by using the control information of the first network entity 100, and
transmit wireless signals towards and/or receive wireless signals transmitted by, the wireless device 10.

According yet other to embodiments of the disclosure the second network entity 200 may be an Artificial Intelligence, AI, reinforced network entity. The AI reinforced entity can also support all types of neural networks, such as feed-forward, convolutional, echo state network, support vector machine, or recurrent neural networks. The AI reinforced entity can support reinforcement learning techniques to learn how to optimize the communication with the device, the entity may for example support, q-learning or contextual bandits.

According to embodiments, the AI reinforced network entity may comprise computer program enabled, autonomous AI functionality used to solve network entity self-contained problems. Thereby the second network entity 200 may be configured to provide a Machine Learning, ML, based air-interface 20 between for example the wireless device 10 and the second network entity 200. According to various embodiments the Machine Learning, ML, based air-interface 20 may configured for:
a) handling and/or improving data transmission between the wireless device 10 and the second network entity 200, or
b) positioning and sensing. Sensing may for example comprise methods for using properties of wireless communication networks for weather prediction.

According to further embodiments of the disclosure the Machine Learning (ML) based air-interface 20 may be trained by means of the control information. Training of the ML based air-interface 20 may for example comprise what bits the second network entity 200, also referred to as ML-node, can expect from the wireless device 10, i.e. UE, and the second network entity 200 may for example feedback the loss, where the loss can comprise the Cross Entropy Loss or Negative Log Likelihood between the received and expected bits. The wireless device 10 can also perform backpropagation and feedback the result from its trainable modules, such as the decoder neural network. Using the wireless device 10 feedback of backpropagation, the second network entity 200 can continue the backpropagation on its trainable parameters. Thereafter, the second network entity 200 may update its trainable parameters (updated weights) and signal the trainable parameters (updated weights) located at the wireless device 10 via the control information.

The ML based air-interface 20 may further update/train a potential autoencoder (encoder and decoder), trained by the second network node 200, based on the loss, feedback and backpropagation result.

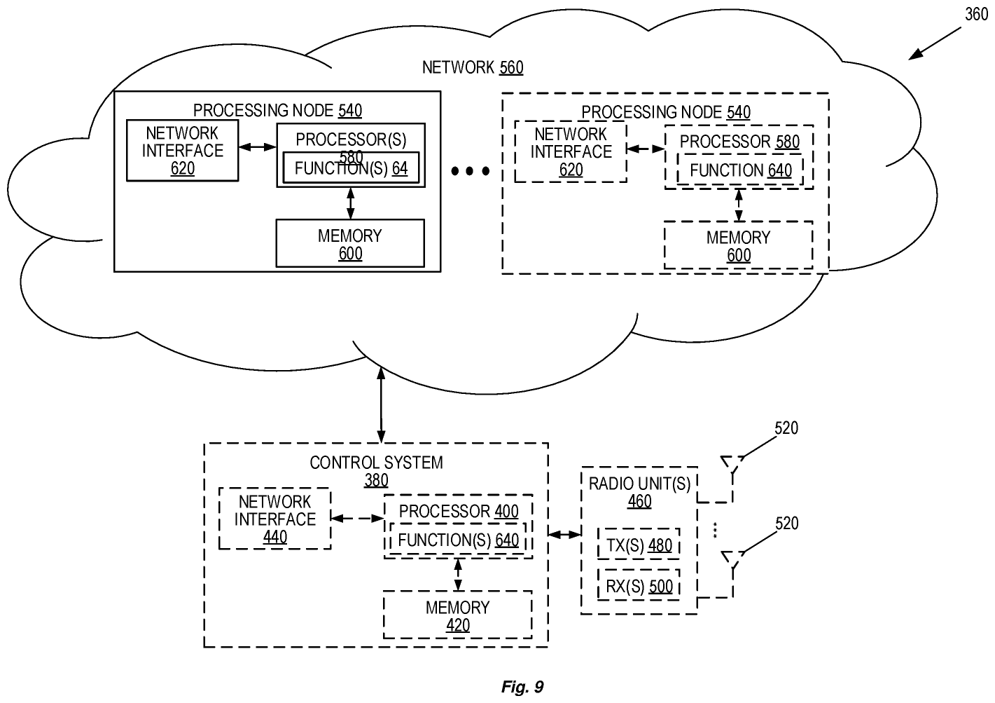

FIG. 9 is a schematic block diagram that illustrates a virtualized embodiment of a network entity 360, hereinafter referred to as network node, (for example a first or second network entity 100, 200) according to some embodiments of the present disclosure. As used herein, a “virtualized” network node 360 is a network node 360 in which at least a portion of the functionality of the network node 360 is implemented as a virtual component (for example, via a virtual machine(s) executing on a physical processing node(s) in a network(s)). As illustrated, the network node 360 optionally includes the control system 380. In addition, if the network node 360 is a radio access node, the network node 360 also includes the one or more radio units 460. The control system 380 (if present) is connected to one or more processing nodes 540 coupled to or included as part of a network(s) 560 via the network interface 440. Alternatively, if the control system 380 is not present, the one or more radio units 460 (if present) are connected to the one or more processing nodes 540 via a network interface(s). Alternatively, all of the functionality of the network node 360 described herein may be implemented in the processing nodes 540. Each processing node 540 includes one or more processors 580 (for example, CPUs, ASICs, DSPs, FPGAs, and/or the like), memory 600, and a network interface 620.

In this example, functions 640 of the network node 360 described herein are implemented at the one or more processing nodes 540 or distributed across the control system 380 (if present) and the one or more processing nodes 540 in any desired manner. In some particular embodiments, some or all of the functions 640 of the network node 360 described herein are implemented as virtual components executed by one or more virtual machines implemented in a virtual environment(s) hosted by the processing node(s) 540. As will be appreciated by one of ordinary skill in the art, additional signalling or communication between the processing node(s) 540 and the control system 380 (if present) or alternatively the radio unit(s) 460 (if present) is used in order to carry out at least some of the desired functions. Notably, in some embodiments, the control system 380 may not be included, in which case the radio unit(s) 460 (if present) communicates directly with the processing node(s) 540 via an appropriate network interface(s).

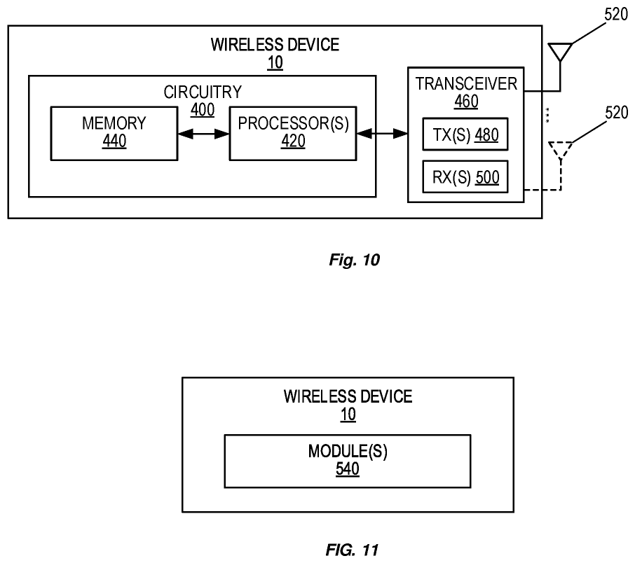

FIG. 10 is a schematic block diagram of a wireless device 10, also referred to as User Equipment (UE), according to some embodiments of the present disclosure. A non-exhaustive list of exemplary wireless devices 10, or UEs, are mobile phones, tablets, smart watches and laptops, but in other embodiments wireless devices 10 can also be connected vehicles, remote surgery equipment, connected industrial machines, connected appliances and sensors. As illustrated, the wireless device 10 may for example include processing circuitry 400 comprising one or more processors 420 (for example, CPUs, ASICs, FPGAs, DSPs, and/or the like) and memory 440. The wireless device 10 also includes one or more transceivers 460 each including one or more transmitters 480 and one or more receivers 500 coupled to one or more antennas 520. In some embodiments, the functionality of the wireless device 10 described above may be implemented in hardware (for example, via hardware within the circuitry 400 and/or within the processor(s) 420) or be implemented in a combination of hardware and software (for example, fully or partially implemented in software that is, for example, stored in the memory 440 and executed by the processor(s) 420).

In some embodiments, a computer program including instructions which, when executed by the at least one processor 420, causes the at least one processor 420 to carry out at least some of the functionality of the wireless device 10 according to any of the embodiments described herein is provided.

In some embodiments, a carrier containing the aforementioned computer program product is provided. The carrier is one of an electronic signal, an optical signal, a radio signal, or a computer readable storage medium (for example, a non-transitory computer readable medium such as memory).

FIG. 11 is a schematic block diagram of a wireless device 10 according to some other embodiments of the present disclosure. The wireless device 10 includes one or more modules 540, each of which is implemented in software. The module(s) 540 provide the functionality of the wireless device 10 described herein.

According to embodiments of the disclosure, the wireless device 10 may be configured to:
transmit capabilities in supporting communication, by means of a first wireless communication system, towards a first network entity, the capabilities in supporting communication comprising capabilities of the wireless device 10 in supporting communication to a second network entity,
receive control information, by means of the first wireless communication system, transmitted by the first network entity in response to having transmitted the capabilities in supporting communication towards the first network entity,
wherein the control information comprises information defining how to receive and/or transmit wireless signals transmitted by/towards the second network entity by using the control information of the first network entity, and
transmitting wireless signals towards and/or receiving wireless signals transmitted by, a second network entity.

In another embodiment, there is provided a computer program comprising computer-executable instructions, or a computer program product comprising a computer readable medium, the computer readable medium having the computer program stored thereon, wherein the computer-executable instructions enabling a wireless device to perform the method steps of any one of, or a combination of, embodiments disclosed herein, when the computer-executable instructions are executed on a processing unit of a wireless device.

According to yet other embodiments, there is provided a computer program comprising computer-executable instructions, or a computer program product comprising a computer readable medium, the computer readable medium having the computer program stored thereon, wherein the computer-executable instructions enabling a first or second network entity to perform the method steps of any one of, or a combination or, embodiments disclosed herein, when the computer-executable instructions are executed on a processing unit of a network entity.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (for example Java interpreter instructions). Alternatively, one or more or all of the sub-routines may be stored in at least one external library file and linked with a main program either statically or dynamically, for example at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed disclosure, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In order to put the present disclosure into context, the disclosure, and embodiments thereof, is hereinafter described in a wider context, disclosing not only the present disclosure but also other ways in which AI techniques may be used in future communication networks.

Data driven algorithms should only replace or complement traditional design algorithms if there is an overall performance gain. In essence, AI techniques can be used to augment existing functions by providing useful predictions as input, replace a rule-based algorithm, and optimize a sequence of decisions such as resource management, mobility, admission control, and beamforming.

In this regard, existing literature, for example scientific papers, have investigated the application of machine learning (ML) techniques to the wireless networking domain. However, scientific papers do not investigate the challenges and network changes required for aligning ML techniques to problems in wireless networking.

### II. Key Factors for Successful AI Deployment

Next-generation wireless networks must support flexible, programmable data pipelines for the volume, velocity and variety of real-time data and algorithms capable of real time decision making. Communication networks must be AI-centric, i.e., the network must no longer be built to transport user-data but rather designed to support AI exchange of data, models, and insights and it is the responsibility of the AI agents to include any necessary user data. As such, future networks must have the ability to meet such requirements. In this section, we provide an overview on the distribution of network intelligence and ML based air-interface, which are key components for designing AI-centric networks.

### A. Distribution of Network Intelligence

Future wireless networks will integrate intelligent functions across the wireless infrastructure, cloud, and end-user devices with the lower-layer learning agents targeting local optimization functions while higher-level cognitive agents pursuing global objectives and system-wide awareness. In this regard, it is important to differentiate between autonomous node-level AI, localized AI, and global AI.
Autonomous node-level AI is used to solve self-contained problems at individual network components or devices, where no data is required to be passed through the network. Such network entities or network nodes are herein generally referred to as AI nodes or AI reinforced network entities.
Localized AI is where AI is applied to one network domain. Localized AI requires data to be passed in the network, however, is constrained to a single network domain, for example, radio access network or core network. Localized AI can also refer to scenarios where data is geographically localized.
Global AI is where a centralized entity requires knowledge of the whole network and needs to collect data and knowledge from different network domains. Network slice management and network service assurance are examples of global AI.

Table 1, shown in FIG. 4, summarizes the benefits and challenges of autonomous node-level AI, localized AI, and global AI. Here, it is important to investigate how to deploy global AI—a global AI per slice, a super-AI that balances slices, or different isolated systems. Other challenges in this scope are the orchestration of different AI modules and the negotiation among AI agents on the available radio resources. To meet the requirements of all lower-level AI agents/user-reflecting AI agents at the same time will result in some resource shortage and negotiations will be necessary. An important aspect is to coordinate such intelligence across different network domains in order to optimize the end-to-end network performance. This in turn has implications for system architecture—how to distribute the models and knowledge bases over the cloud, edge, and devices (centralized versus distributed learning); whether model training should be offline or online; how to represent and prepare data for fast consumption by algorithms; short-time scale versus long-time scale applications.

For instance, centralized AI schemes can be challenging for some wireless communication applications due to the privacy of some features such as user location and limited bandwidth and energy for transmitting a massive amount of local data to a centralized cloud for training and inference. This in turn necessitates new communication-efficient training algorithms over wireless links while making real-time and reliable inferences at the network edge. Here, distributed machine learning techniques have the potential to provide enhanced user privacy and energy consumption. Such schemes enable network devices to learn global data patterns from multiple devices without having access to the whole data. This is realized by learning local models based on local data, sending the local models to a centralized cloud, averaging them and sending back the average model to all devices. Nevertheless, the effectiveness of such schemes in real networks should be further studied considering the limitations of processing power and memory of edge devices. As such, configurations for centralized, distributed, and hybrid architectural approaches should be supported. Moreover, it is vital to design a common distributed and decentralized paradigm to make the best use of local and global data and models.

### B. ML Based Air-Interface

Future wireless networks might comprise a fully end-to-end machine learning air-interface. In this respect, the challenges are training an interface that does not only support efficient data transmissions but also reduces the energy consumption while fulfilling latency demands for each application. While an ML air-interface might be trained for optimizing the data transmission, it might be challenging for an AI-solution to handle typical control channel problems such as being energy efficient in situations where no data is transmitted nor received. Moreover, the latency demand can vary depending on the use case, for example factory connectivity requires stringent latency demands compared to mobile broadband. The challenges for an ML air-interface system are extensive, since it needs an AI that can both optimize and trade-off between data throughput, energy efficiency, and latency. This necessitates an alternative approach for initial AI deployment, focusing on an ML air-interface targeting one of the above aspects, preferably data transmissions improvement. Note that this is similar to the first new radio (NR) non-standalone deployments where NR is introduced for enhanced mobile broadband to provide higher data-bandwidth and reliable connectivity while being aided by existing 4G infrastructure.

In NR non-standalone, the network uses an NR carrier mainly for data-rate improvements, while the LTE carrier is used for non-data tasks such as mobility management and initial cell search. A potential future ML air-interface 20 illustrated in FIG. 1 could be designed in a similar manner for data-rate improvements, leveraging the scenario-specific adaptation powered by AI. The primary radio access technology (RAT) could be used for training the ML air-interface 20 and for controlling signalling. Such signalling can detail how the users, i.e. UEs 10, should communicate on the ML-air-interface 20 such as sending the structure and weights of a Neural Network (NN) or indicating when/where the UE 10 should receive data. Here, it is important to investigate the data volume for such transmissions and how long must the user-session be for such a scheme to be beneficial.

Neural network; The skilled person will be familiar with neural networks (NN), also referred to as Artificial Neural Network (ANN), however, briefly, a NN can generally be described as a network, designed to resemble the human brain, formed by a collection of connected neurons, or nodes, in multiple layers. A NN generally comprises at least one input node of an input layer, a number of hidden layers comprising a number of nodes or neurons, and finally an output layer. Each node of a layer is connected to a number of nodes of preceding layer, i.e. nodes of the most recent higher layer, and a number of nodes in directly subsequent layer, i.e. the following lower layer. The more layers, the deeper the neural network. Input provided to the input layer travels from the first layer (the input layer), to the last layer (the output layer), possibly after traversing the layers multiple times. The nodes of a layer may be either fully connected, i.e. connected to all nodes of higher and lower layers, or connected to just a few of the nodes of a higher and/or lower layer. The output of each node is computed by for example a non-linear function of the sum of its inputs. Different layers and different nodes may perform different transformations on their inputs. The connections are sometimes referred to as edges, and edges typically have a weight that adjusts as learning of the NN proceeds. The skilled person will be familiar with methods of training a NN using training data (for example gradient descent etc.) and appreciate that the training data may comprise many hundreds or thousands of rows of training data (depending on the accuracy required of the trained model), obtained in a diverse range of network conditions. But in general terms, training of a NN network is performed by applying a training data set, for which the correct outcome is known, and iterate that data through the NN. During training of the NN the weights associated with respective node, or connection from respective node, increase or decrease in strength, meaning that how probable it is that a specific connection, out of the many possible, from a node, that is selected when a node is reached is adjusted. Generally, for each training iteration of the NN the chance that the outcome of the NN is correct increases.

Put another way, a Neural Network (NN) is a type of supervised Machine Learning (ML) model that can be trained to predict a desired output for given input data. NNs are trained by providing training data comprising example input data and the corresponding “correct” or ground truth outcome that is desired. Neural networks comprise a plurality of layers of nodes or neurons, each node representing a mathematical operation that is applied to the input data provided to that node. The output of each layer in the neural network is fed into the next layer to produce an output. For each piece of training data, weights associated with the neurons are adjusted until the optimal weightings are found that produce predictions for the training examples that reflect the corresponding ground truths.

Training the network could comprise of what bits the receiver should expect from the transmitter and what the receiver could feedback such as the loss. The network could update/train a potential auto-encoder based on the loss and feedback the updated weights to the transmitter/receiver. The encoder part of the autoencoder would be at the transmitter side and the decoder at the receiver side. Having highlighted on the AI deployment issues, next, we summarize some of the main challenges that require further investigation for reaping the benefits from integrating AI tools in future networks.

### III. Key Factors for Successful AI Integration

To reap the benefits from integrating AI in wireless networks, AI tools must be tailored to the unique features and needs of the wireless networks which are significantly different from the traditional applications of AI. In this section, we highlight on some of the main areas that must be further investigated to realize the synergistic integration of AI in future wireless networks.

### A. Data

Acquiring and labelling data is fundamental. The process needs to consider the privacy of some radio-based features, measurement accuracy, sensor precision, real-time data collection, measurements across large scaled infrastructure, and the need of domain knowledge expertise. Additional device measurements or device reports might also be needed for some AI-based wireless applications to improve the performance of data-driven decisions in mobile networks.

### B. Security

The success of integrating AI in next-generation wireless networks will not only depend on the capability of the technology but also on the security provided to the data and models. It is crucial to guarantee obtaining accurate data sets and AI models by avoiding data from false base stations or compromised network devices. For instance, it is crucial to rely on federated learning schemes with trusted updates to defend from malicious edge nodes thus guaranteeing that the exchanged network intelligence between the different network nodes and the cloud is reliable i.e., poisoning attack. Moreover, secure schemes are necessary for sharing data and network intelligence across different network devices and domains.

### C. Confidential Computing

A confidential computing multi-party data analytic with secure enclaves is an interesting technology with the potential for security and privacy improvements for AI applications. Confidential computing can increase the end-user's and the network operator's trust in AI applications to the wireless network domain by ensuring that operators can be confident and that their confidential customer and proprietary data is not visible to other operators.

D. Efficient AI implementation

An AI model can be transferred from the network to the end-user device(s), an approach known as downloadable AI. The transferred model can include input features and model parameters such as neural network weights and structure. Here, model training, data and model storage, data and model transfer, data format, and online model update should be considered for the efficient implementation of AI algorithms in network devices. For instance, model update can be triggered by new quality of experience (QoE) metric such as the loss function or when the model output is above a threshold. It is also essential to develop downloadable AI device-based models as opposed to having one unique downloadable AI model for all types of devices thus accounting for the different memory limitations and computational capabilities of the network devices. Moreover, it is crucial to investigate model compression and acceleration techniques for model transfer without significantly degrading the model performance. Existing deep neural network models, for example, are computationally expensive and memory intensive, hindering their deployment in devices with low memory resources (for example, memory, CPU, energy, bandwidth) or in applications with strict latency requirements.

### E. Reinforcement Learning in Cellular Networks

Reinforcement learning is a type of machine learning scheme where the algorithm continuously interacts with its environment and is given implicit and sometimes delayed feedback in the form of reward signals. Reinforcement learning performs short-term reward maximization but can also take short-time irrational decisions for long-term gains. Such algorithms try to maximize the expected future reward by exploiting already existing knowledge and exploring the space of actions in different network scenarios. Reinforcement learning will be further discussed below. However, exploration in real environments might cause short-term performance degradation and hence the level of exploration can be much lower or even zero in a critical communication setting whereas in mobile broadband settings the acceptance for short-term performance degradation is higher. In this regard, new approaches such as pre-training, transfer learning, shared learning, semi-supervised reinforcement learning, and the use of simulation-in-the-loop techniques are being investigated. One can also identify network conditions for the underlying use case under which exploration can still guarantee the promised quality-of-service to the connected devices. Moreover, it is important to note that, while in single-agent reinforcement learning scenarios the state of the environment changes solely as a result of the actions of an agent, in multi-agent reinforcement learning scenarios the environment is subjected to the actions of all agents. This can result in misleading reward values, slow convergence rate (or even non-convergence), and curse of dimensionality. Partial observability and sampling efficiency are also key aspects for enabling reinforcement learning techniques in real cellular networks.

### F. Faster Training Process

To realize the efficiency of AI-based techniques in wireless networks, it is crucial to devise new techniques/algorithms for a faster training process. For instance, one could initiate the machine learning model offline based on simulated data or use conventional algorithms during the exploitation phase and then do time sharing with a comparably short exploration phase where possibly the user experience is not much impacted. Human knowledge and theoretical reasoning are important for limiting the space that ML solutions need to explore thus improving performance and speeding up the training process. Transfer knowledge from a source domain to a target domain is also an essential technique given that mobile network environments often exhibit changing environment over time. Transfer learning is of particular interest for scenarios where the number of samples in the target domain is relatively small or in case data becomes available at a relatively small-time scale. In such scenarios, the model should have transfer learning ability enabling the fast transfer of knowledge from pre-trained models to different jobs or datasets.

Reinforcement learning; The skilled person will be familiar with reinforcement learning, herein also referred to as RL, and reinforcement learning agents, however, briefly, reinforcement learning is a type of machine learning process whereby a reinforcement learning agent (for example algorithm) is used to perform actions on a system (such as for example a communications network) to adjust the system according to an objective (which may, for example, comprise moving the system towards an optimal or preferred state of the system). The reinforcement learning agent receives a reward based on whether the action changes the system in compliance with the objective (for example towards the preferred state), or against the objective (for example further away from the preferred state). The reinforcement learning agent therefore adjusts parameters in the system with the goal of maximising the rewards received.

Put more formally, a reinforcement learning agent receives an observation from the environment in state S and selects an action to maximize the expected future reward r. Based on the expected future rewards, a value function V for each state can be calculated and an optimal policy π that maximizes the long-term value function can be derived.

To give an example, the communications network is the “environment” in the state S. The “observations” are values relating to the process associated with the communications network that is being managed by the reinforcement learning agent and the “actions” performed by the reinforcement learning agents are the adjustments made by the reinforcement learning agent that affect the process that is managed by the reinforcement learning agent. Generally, the reinforcement learning agents herein receive feedback in the form of a reward or credit assignment every time they perform an adjustment (for example action). As noted above, the goal of the reinforcement learning agents herein is to maximise the reward received.

Examples of algorithms or schemes that may be performed by the RL agent described herein include, but are not limited to, Q learning, deep Q Network (DQN), and state-action-reward-state-action (SARSA). The skilled person will appreciate that these are only examples however and that the teachings herein may be applied to any reinforcement learning scheme whereby random actions are explored.

When a RL agent is deployed, the RL agent performs a mixture of “random” actions that explore an action space and known or previously tried actions that exploit knowledge gained by the RL agent thus far. Performing random actions is generally referred to as “exploration” whereas performing known actions (for example actions that have already been tried that have a more predictable result) is generally referred to as “exploitation” as previously learned actions are exploited.

### G. AI Alignment

It is interesting to enable the AI agent to interact with the user thus taking into consideration the user's goals and intentions during the learning phase. This is essentially known as the AI alignment problem which can be defined as “how to align the behaviour of AI networks to human goals and intents?” and is indispensable for wireless applications where a built-in reward function is not available. The interaction between humans and machines will build trust and enable the machines to adjust their action to human's intentions based on a suitable key performance indicator. Meanwhile, it is crucial to make sure that the AI alignment does not result in behaviour that is harmful to the network. A set of rules within which the AI can be aligned to the users desires but not cause general harm should be established.

One embodiment of the disclosure comprises a method of designing a reward function comprising the method step of: enabling the AI agent to interact with a user, wherein interacting with the user comprises taking into consideration the user's goal and intentions.

This has the effect that when applying the reinforcement learning algorithm the user's goals and intentions are considered whereby the AI which, as previously mentioned, potentially will build trust and enable the machines to adjust their action to human's intentions.

According to one aspect of this embodiment the method is performed during a learning phase.

### H. Active Learning

ML still requires extensive human knowledge, experience, and planning. As mobile networks generate considerable amount of unlabelled data, data labelling becomes costly and requires domain-specific knowledge. In this regard, one can employ active learning schemes in the network where the algorithm can explicitly request labels to individual data samples from the user. For instance, one could rely on humancentered AI models where the human is incorporated into the learning system enabling the AI system to learn from and collaborate with humans for realizing an efficient data annotation process.

### I. Real-Time Network Intelligence

Real-time requirements entail that predictions, model updates, and inferences from knowledge bases are based on live-streaming data. This in turn necessitates the development of adaptive online learning schemes that can rely on the availability of data online, real-time data labelling, and real-time processing with strict latency requirements. Here, it is important to note that the value of AI in next generation cellular networks can be realized with the continued evolution of the base station capabilities. Future base stations should support the required levels of observability, processing capability, memory, and backhaul capacity. Next, we summarize various applications of ML techniques to wireless networking.

### J. Explainable AI

Explainable AI refers to techniques where the outcome of the ML models is explainable and therefore aims to address how black box decisions of AI systems are made. Such machine-learning systems will have the ability to explain their rationale, characterize their strengths and weaknesses, and convey an understanding of how they will behave in the future. Explainable AI can therefore increase the operators trust in data-driven algorithms when considering AI applications in future networks. Here, it is important to produce more explainable models while maintaining a high level of learning performance (i.e., prediction accuracy).

### IV. Applications of AI in Wireless Networking

AI will inevitably be integrated at different levels of the network enabling operators to predict context information, adapt to the network changes, and proactively manage radio resources to achieve the network-level and user-level performance targets. AI-based solution schemes will be incorporated into existing networks on the short and long term. On a short term, applications of AI will mainly target separate network blocks such as scheduler and mobility management entity for the different service classes. On a long-term perspective, AI cross-layer design and optimization based on new QoE-based metrics is necessary for satisfying the end-to-end network performance requirements. Here, one would expect protocols to be designed by violating the reference architecture, allowing direct communication between protocols at non-adjacent layers, sharing variables, or joint tuning of parameters across different layers.

Applications of AI techniques to the wireless network domain will essentially rely on various input features—radio-based features such as radio location and channel state information and non-radio features such as geographical location and weather conditions. For instance, the radio location comprises radio measurements on reference signals of the UE serving frequencies and is useful for different applications such as signal quality prediction, secondary carrier prediction, user trajectory prediction, and beam alignment. Nevertheless, acquiring frequent UE measurements is costly and can result in a large overhead. As such, it is important to investigate new efficient UE reporting formats and new report trigger events to reduce signalling-based measurements. Next, we elaborate on the application of ML techniques to different networking problems while highlighting on particular use cases.

### A. AI for Physical Layer

The recent advancements in large steerable antenna arrays and cell-free architecture necessitates more coordination at the base stations. For example, forming the signal on each transmit antenna to maximize the signal quality at the UE side under imperfections such inter-node interference, channel estimation error, and antenna imperfections can be improved by machine learning techniques. Other physical layer improvements using AI can in a first stage comprise improving separate modules in the transmission chain, for example an ML based modulation, while using orthogonal frequency-division multiplexing for signal generation of the modulated symbols.

FIG. 5 exemplifies such system, where the trainable modules, the modulation layer, and the demodulation layer are shown. Using this architecture, we exemplify the system with a single UE and a base station equipped with a large antenna array performing maximum ratio transmission precoding assuming perfect channel estimates (estimated using for example UE sounding). One of the main challenges using an ML based physical layer is to handle the channel distortion. By utilizing results from, we note that precoding the signal using MRT in a single antenna terminal deployment achieves a zero-phase with non-additive white gaussian noise channels. Although the phase can be zeroed due to channel hardening, the amplitude of the effective instantaneous channel remains unknown. We consider an example where the network trains an autoencoder comprising the modulation (encoder) and demodulation (decoder) and the base station intends to transmit 3 bits using a single carrier. Autoencoder will be further discussed below. Note that the non-trainable layers are part of the learning but does not have any trainable weights. The training can be performed using the concept described in Section 113, where the UE receives the intended bits to be received on a primary carrier and feedback for example the loss and its neural network gradients on a secondary carrier. We evaluate the trained decoder network by feeding different non-equalized received symbols in the single carrier deployment into the decoder. The resulting class regions are illustrated in FIG. 6. FIG. 6 shows how the trained decoder can split its received non-equalized symbols into different regions where each region comprises a unique class (8 possible classes for the considered 3 bit setup). Results show that the setup can learn how to communicate with an unknown effective channel gain highlighting on the ability of the encoder/decoder to estimate the received bits by using the phase-information of the received symbol.

Autoencoder; The skilled person will be familiar with autoencoders, but briefly, autoencoders are a type of machine learning algorithm that may be used to concentrate data. Autoencoders are trained to take a set of input features and reduce the dimensionality of the input features, with minimal information loss. Training an autoencoder is generally an unsupervised process, as the autoencoder is divided into two parts, an encoding part and a decoding part. The encoder and decoder may comprise, for example, deep neural networks comprising layers of neurons. An encoder successfully encodes or compresses the data if the decoder is able to restore the original data stream for example within a tolerable loss of data. Training may comprise reducing a loss function describing the difference between the input (raw) and output (decoded) data. Training an encoder thus involves optimising the data loss of the encoder process. An autoencoder may be considered to concentrate the data (for example as opposed to merely reducing the dimensionality) because essential or prominent features in the data are not lost. A stacked autoencoder comprises two or more individual autoencoders that are arranged such that the output of one is provided as the input to the other autoencoder. In this way, autoencoders may be used to sequentially concentrate a data stream, the dimensionality of the data stream being reduced in each autoencoder operation.

Put another way a stacked autoencoder provides a dilatative way to concentrate information along the whole intelligence data pipeline. Also, due to the fact that each autoencoder residing in each node (or processing unit) is mutually chained, it may provide the advantage that the stacked autoencoder can grow according to the information complexity of the inputted data dimensions.

### B. AI for Radio Resource Allocation

Radio resource allocation problems such as scheduling, beamforming, and beam alignment are generally known to be NP-hard. In this regard, ML based techniques can aid in providing heuristic solutions to these problems. Consider for instance the beam alignment problem, which corresponds to finding the best transmitter and receiver beam pair in the codebook based on some network parameters such as signal to noise and interference ratio. This technique is generally used to avoid estimating the channel directly when a very large number of transmit and receive antennas are used. The beam alignment procedure can take long time since one would need to go through all the codebook(s) to find the best pair during the search period. Here, ML based techniques can be designed to avoid the exhaustive search approach in finding the best beam index according to a fixed codebook.

### C. AI for Mobility Management

Current wireless networks rely on reactive schemes for mobility management. However, such schemes might induce high latency that can be unfavourable for new emerging applications such as connected vehicles and factory automation. Machine learning techniques allow proactive mobility decisions, thus enabling seamless mobility experience in highly dynamic environments. For instance, ML techniques can allow sudden signal quality drop prediction and secondary carrier link quality prediction, thus improving the user's mobility experience.

Future networks will operate on 28 GHz leading to higher data rates and network capacity. The 28 GHz deployment, however, leads to less favourable propagation in comparison to lower frequencies, resulting in spotty coverage, at least in initial 28 GHz deployments. In order for the UEs to utilize also a potential spotty coverage on higher frequencies, the UEs need to be configured to perform inter-frequency measurements, which could lead to high measurement overhead at the device. An unnecessary inter-frequency measurement occurs when UEs are not able to detect any 28 GHz node, while not configuring a UE to perform inter-frequency measurements can result in under-utilizing the large spectrum available at 28 GHz.

To limit the measurements on a secondary carrier, an ML scheme for predicting the coverage on the 28 GHz band based on measurements at its serving 3.5 GHz carrier node can be used. FIG. 7a shows the coverage for the 3.5 GHz and 28 GHz for an exemplary scenario. In this scenario, the 3.5 GHz node that is serving the UEs sweeps 48 beams and the UEs send reports for the beam strength of each beam. Using secondary carrier prediction with the 48 beams signal strength measurements as input, the coverage on the 28 GHz node deployed in the same area is predicted, resulting in energy savings at the UE. The predicted 28 GHz coverage probability using 3.5 GHz measurements with a random forest classifier is illustrated in FIG. 7b. Here, note that with 36% of the samples having coverage on the 28 GHz, the accuracy score was 87%.

### D. AI for Wireless Security

Maintaining high level of security for new use-cases and upon introducing AI in cellular networks is crucial for next generation wireless cellular networks. Alongside the data and model security issues mentioned earlier in Section III, ML techniques can be adopted for enhancing network security such as false base station identification, rogue drone detection, and network authentication. For instance, detecting rogue cellular connected drones is an important network feature. This issue has drawn much attention since the rogue drones may generate excessive interference to mobile networks and may not be allowed by regulations in some regions. In this regard, machine learning classification methods can be utilized for identifying rogue drones in mobile networks based on reported radio measurements.

### E. AI for Localization

New applications such as intelligent transportation, factory automation, and self-driving cars are important areas that drive the need for localization enhancements. The potentials with AI-based localization in wireless networks are expected to increase with the massive antennas and new frequency bands in 5G deployments which in turn allow for more unique radio-signal-characteristics for each location, leading to improved localization accuracy using for example finger printing techniques. Moreover, new methods that can utilize map information to predict the reflected paths of a signal transmitted from a UE are crucial. An AI framework that uses a combination of the received signal along with map information can yield high accuracy location estimation.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

### REFERENCES INCORPORATED

[1] M. Chen, U. Challita, W. Saad, C. Yin, and M. Debbah, “Artificial neural networks-based machine learning for wireless networks: A tutorial,” IEEE Communications Surveys & Tutorials, July 2019.
[2] D. Gunduz, P. de Kerret, N. Sidiropoulos, D. Gesbert, C. Murthy, and M. van der Schaar, “Machine learning in the air,” arXiv:1904.12385, April 2019.
[3] U. Challita, A. Ferdowsi, M. Chen, and W. Saad, “Machine learning for wireless connectivity and security of cellular-connected uavs,” IEEE Wireless Communications, vol. 26, no. 1, pp. 28-35, February 2019.
[4] C. Jiang, H. Zhang, Y. Ren, Z. Han, K. Chen, and L. Hanzo, “Machine learning paradigms for next-generation wireless networks,” IEEE Wireless Communications, vol. 24, no. 2, pp. 98-105, April 2017.
[5] Y. Sun, M. Peng, Y. Zhou, Y. Huang, and S. Mao, “Application of machine learning in wireless networks: Key techniques and open issues,” IEEE Communications Surveys Tutorials, To appear 2019.
[6] J. Leike, D. Krueger, T. Everitt, M. Martic, V. Maini, and S. Legg, “Scalable agent alignment via reward modeling: a research direction,” arXiv:1811.07871, November 2018.
[7] M. Riedl, “Human-centered artificial intelligence and machine learning,” arXiv:1901.11184, January 2019.
[8] L. Fridman, L. Ding, B. Jenik, and B. Reimer, “Arguing machines: Human supervision of black box AI systems that make life-critical decisions,” CoRR, vol. abs/1710.04459, 2019. [Online]. Available: http://arxiv.org/abs/1710.04459.
[9] H. Ngo and E. Larsson, “No downlink pilots are needed in TDD massive MI MO,” IEEE Transactions on Wireless Communications, vol. 16, no. 5, pp. 2921-2935, March 2017.
[10] B. Halvarsson, A. Simonsson, A. Elgcrona, R. Chana, P. Machado, and H. Asplund, “5G NR testbed 3.5 GHz coverage results,” in IEEE 87^{th} Vehicular Technology Conference (VTC 2018-Spring). Porto, Portugal, June 2018.
[11] H. Ryden, S. B. Redhwan, and X. Lin, “Rogue drone detection: A machine learning approach,” in IEEE Wireless Communications and Networking Conference (WCNC). Marrakech, Morocco, April 2019.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1×Radio Transmission Technology
3GPP 3rd Generation Partnership Project
5G 5th Generation
ABS Almost Blank Subframe
AI Artificial Intelligence
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eMBB enhanced Mobile Broadband
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
FFT fast Fourier Transform
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
mMTC massive Machine Type Communications
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
ML Machine Learning
NPDCCH Narrowband Physical Downlink Control Channel
NR New Radio
NN Neural Network
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
QoS Quality of Service
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
URLLC Ultra Reliable Low Latency Communications
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1-39. (canceled)

40. A method for managing a network interface of a communication network, the communication network comprising a Radio Access Network (RAN), the method comprising a wireless device in the communication network:
transmitting capabilities in supporting communication, by means of a first wireless communication system, towards a first network entity; the capabilities in supporting communication comprising capabilities of the wireless device in supporting communication to a second network entity;
receiving control information, by means of the first wireless communication system, transmitted by the first network entity in response to the wireless device transmitting the capabilities in supporting communication towards the first network entity; wherein the control information comprises information defining how to receive and/or transmit wireless signals transmitted by/towards the second network entity by using the control information of the first network entity; and
transmitting wireless signals towards and/or receiving wireless signals transmitted by, the second network entity.

41. The method of claim 40:
wherein the second network entity is an Artificial Intelligence (AI) reinforced network entity; and
wherein the capabilities in supporting communication, transmitted by the first network entity, comprise information supporting providing a Machine Learning (ML) based air-interface between the wireless device and the second network entity.

42. The method of claim 41, wherein the ML based air-interface is configured for handling and/or improving data transmission between the wireless device and the second network entity.

43. The method of claim 41, wherein the control information enables:
training of the ML based air-interface; and/or
controlling wireless signaling between the wireless device and the second network entity.

44. The method of claim 40, wherein the capabilities in supporting communication comprise information regarding:
frequencies and bandwidths supported by the wireless device;
processing capabilities of the wireless device;
one or more supported neural network configurations that can be processed by the wireless device;
energy requirements of the wireless device;
throughput requirements of the wireless device;
latency requirements of the wireless device;
reliability requirements of the wireless device;
information regarding if the wireless device is capable of assisting in training a Machine Learning (ML) based air-interface;
information regarding capabilities of storing data and/or storing ML models of the wireless device; and/or
a unique identifier or identity of the wireless device.

45. The method of claim 40, wherein the control information comprises information regarding:
data package size of data packages being transmitted between the wireless device and the second network entity;
time-frequency resources and data packet(s) where the wireless device should transmit its uplink transmission; and/or
time-frequency resources and data packet(s) where the wireless device can expect to receive a downlink transmission from the second network entity;
a machine learning (ML) model describing how to decode a wireless signal transmitted from the second network entity, comprising data intended for the wireless device; wherein the ML model describing how to decode the signal comprises information regarding:
Neural Network (NN) structure; and/or
NN weights for decoding the signal.

46. The method of claim 45:
wherein the second network entity is an Artificial Intelligence (AI) reinforced network entity; and
wherein the capabilities in supporting communication, transmitted by the first network entity, comprise information supporting providing a Machine Learning (ML) based air-interface between the wireless device and the second network entity;
wherein the control information is used for training the ML based air-interface;
wherein the control information comprises information regarding:
data packet(s) transmitted from the second network entity, or from the wireless device; and/or
a pseudo-random function that can be used to efficiently generate the transmitted data packet from the second network entity, or from the wireless device.

47. A method for managing a network interface of a communication network; the communication network comprising a Radio Access Network (RAN); the method comprising a first network entity in the communication network:
receiving capabilities in supporting communication, by means of a first wireless communication system, transmitted by a wireless device; the capabilities in supporting communication comprising capabilities of the wireless device in supporting communication to a second network entity; and
in response to receiving capabilities in supporting communication transmitted by the wireless device:
transmitting control information, by means of the first wireless communication system, towards the wireless device and by means of a second communication system towards the second network entity;
wherein the control information comprises information defining how to transmit wireless signals between the wireless device and the second network entity by using the control information of the first network entity.

48. The method of claim 47, wherein the method comprises receiving feedback information, by means of the second communication system, transmitted by the second network entity; wherein the feedback information comprises an acknowledgement message acknowledging that the control information is received and/or information about the communication between the wireless device and the second network entity.

49. The method of claim 48, wherein the method comprises updating the control information based on the received feedback information.

50. The method of claim 47:
wherein the second network entity is an Artificial Intelligence (AI) reinforced network entity; and
wherein the capabilities in supporting communication, transmitted by the first network entity, comprises information supporting providing a Machine Learning (ML) based air-interface between the wireless device and the second network entity.

51. The method of claim 50, wherein the ML based air-interface is configured for handling and/or improving data transmission between the wireless device and the second network entity.

52. The method of claim 50, wherein the control information enables:
training the ML based air-interface; and/or
controlling wireless signaling between the wireless device and the second network entity.

53. The method of claim 50, wherein the feedback information comprises:
if receiving data packets using the ML based air-interface:
data packet error information and/or need for re-transmission of a data packet;
output from a neural network (NN) at the wireless device; and/or
application specific events needed for triggering an ML model update; and
if training the ML based air-interface:
bit-error loss; and/or
gradients for backpropagation in a NN; and/or
an acknowledgement message acknowledging that the control information is received.

54. A method for managing a network interface of a communication network; the communication network comprising a Radio Access Network (RAN); the method comprising a second network entity in the communication network:
receiving control information, by means of a second communication system, transmitted by a first network entity; wherein the control information comprises information defining how to receive and/or transmit wireless signals transmitted by/towards a wireless device by using the control information of the first network entity; and
transmitting wireless signals towards and/or receiving wireless signals transmitted by the wireless device.

55. The method of claim 54, wherein the method comprises transmitting feedback information by means of the second wireless communication system; wherein the feedback information comprises an acknowledgement message acknowledging that the control information is received and/or information about the communication between the wireless device and the second network entity.

56. The method of claim 55:
wherein the second network entity is an Artificial Intelligence (AI) reinforced network entity; and
wherein the second network entity is configured to provide a Machine Learning (ML) based air-interface between the wireless device and the second network entity.

57. The method of claim 56, wherein the ML based air-interface is configured for handling and/or improving data transmission between the wireless device and the second network entity.

58. The method of claim 56, wherein the control information enables:
training the ML based air-interface; and/or
controlling wireless signaling between the wireless device and the second network entity.
